(19) United States
(12) Patent Application Publication
(10) Pub. No.: US 2012/0220247 A1
(43) Pub. Date: Aug. 30, 2012

(54) Systems And Methods For Tunable Wavelet Transform Analysis Of A Signal

(75) Inventors: James Ochs, Seattle, WA (US); Paul Addison, Edinburgh (GB); James Watson, Dunfermline (GB)

(73) Assignee: Nellcor Puritan Bennett Ireland, Galway (IE)

(21) Appl. No.: 13/036,361

(22) Filed: Feb. 28, 2011

(51) Int. Cl. H04B 1/18

(52) U.S. Cl. 455/150.1

(57) ABSTRACT

Methods and systems are disclosed for tuning first and second wavelet functions to resolve at least one component of a signal. A first characteristic frequency corresponding to a first scale band of interest is determined, and a first wavelet function is tuned to the first characteristic frequency in at least a region of a first scale band of interest. A second characteristic frequency corresponding to a second scale band of interest is determined, and a second wavelet function is tuned to the second characteristic frequency in at least a region of the second scale band of interest. A signal is transformed for the first and second wavelet functions using a continuous wavelet transform to create a transform signal, and a scalogram is generated based at least in part on the transformed signal.

### SUMMARY OF THE DISCLOSURE

The present disclosure relates to signal processing and analysis and, more particularly, the present disclosure relates to a system and method for tuning a wavelet transform to resolve components of a signal.

Many measurement systems require one or more signal processing steps to determine useful information from a measured signal. In some applications, these signal processing steps include tuning a wavelet transform to resolve individual components within the signal. In connection with deriving useful information (e.g., clinical information) from a physiological signal, tuning a wavelet transform by altering the characteristic frequency of the wavelet transform, may be perform based on one or more criteria. In tuning the wavelet transform, the scale being considered, the nature of the signal component being analyzed, the noise level of the signal, and/or the signal-to-noise ratio of the signal a may be used to determine the appropriate characteristic frequency for one or more wavelet functions used to calculate the wavelet transform. This process of tuning the wavelet transform, as will be described in more detail below, may be used to resolve pulse components out of a physiological signal, making the signal more amenable to analysis and manipulation within subsequent signal processing, (e.g., to determine an S_{P}O₂ value).

According to one aspect, the disclosure relates to a method for processing a signal. The method includes receiving the signal. For example, the received signal may include a photoplethysmograph (PPG) signal. The method further includes using specialized processing hardware and software to determine a first characteristic frequency corresponding to a first scale band of interest. In certain embodiments, a first wavelet function is tuned to the first characteristic frequency in at least a region of the first scale band of interest. In an embodiment, a second characteristic frequency corresponding to a second scale band of interest is determined. In certain embodiments, the a second wavelet function is tuned to the second characteristic frequency in at least a region of the second scale band of interest. In certain embodiments, the signal is transformed using a wavelet transform for the first and second wavelet functions to generate a transform signal. In certain embodiments, a scalogram is generated for at least the first and second scale bands of interest based at least in part on the transform signal.

In an embodiment, the first and second characteristic frequencies are determined such that an amplitude associated with the second band of interest is approximately equal to an amplitude associated with the first band of interest. In certain embodiments, updated first and second characteristic frequencies are determined dynamically in time.

In an embodiment, the first and second characteristic frequencies are determined based at least in part on at least one characteristic of the signal. For example, the at least one characteristic of the signal may be the noise level, signal-to-noise ratio, morphology of signal components, scale, and/or time of occurrence, or a combination thereof. In certain embodiment, at least one of the first and second wavelet functions are tuned to a particular characteristic frequency to produce better definition in the wavelet transform for repeating signal features.

In certain embodiment, the signal is a photoplethysmograph signal. In an embodiment the first band of interest and the second band of interest represent pulse components and breathing components. In an embodiment, at least one physiological parameter is computed based at least in part on the tuning to the first and second characteristic frequencies. In certain embodiments, the wavelet transform is tuned to increase the signal-to-noise ratio.

In an embodiment, a system for processing a signal includes a receiver that receives the signal and specialized processing hardware and software. The specialized processing hardware and software may be capable of determining a first characteristic frequency corresponding to a first scale band of interest and tuning a first wavelet function to the first characteristic frequency in at least a region of the first scale band of interest. The specialized processing hardware and software may further be capable of determining a second characteristic frequency corresponding to a second scale band of interest and tuning a second wavelet function to the second characteristic frequency in at least a region of the second scale band of interest. The specialized processing hardware and software may be further capable of transforming the signal using a continuous wavelet transform for the first and second wavelet functions to generate a transformed signal and generating a scalogram for at least the first and second scale bands of interest based at least in part on the transform signal.

Several methods and systems for tuning a wavelet transform for analysis of a signal are disclosed herein. In a patient monitoring setting, the physiological information determined by a wavelet transform tuning technique may be used in a variety of clinical applications, including within diagnostic and predictive models, and may be recorded and/or displayed by a patient monitor.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows an illustrative pulse oximetry system in accordance with an embodiment;

FIG. 2 is a block diagram of the illustrative pulse oximetry system of FIG. 1 coupled to a patient in accordance with an embodiment;

FIGS. 3(a) and 3(b) show illustrative views of a scalogram derived from a PPG signal in accordance with an embodiment;

FIG. 3(c) shows an illustrative scalogram derived from a signal containing two pertinent components in accordance with an embodiment;

FIG. 3(d) shows an illustrative schematic of signals associated with a ridge in FIG. 3(c) and illustrative schematics of a further wavelet decomposition of these associated signals in accordance with an embodiment;

FIGS. 3(e) and 3(f) are flow charts of illustrative steps involved in performing an inverse continuous wavelet transform in accordance with embodiments;

FIG. 4 is a block diagram of an illustrative continuous wavelet processing system in accordance with some embodiments;

FIG. 5 is a flow chart of a method of signal processing suitable for use by the pulse oximetry systems of FIG. 1 and FIG. 2 and the continuous wavelet processing system of FIG. 4 in accordance with an embodiment;

FIG. 6 is a flow chart of illustrative steps for tuning a wavelet transform in accordance with an embodiment;

FIGS. 7(a) and 7(b) show illustrative plots of two bands in wavelet space in accordance with an embodiment;

FIG. 8 is an illustrative plot of two bands in wavelet space with a wavelet transform computed at an ωₒ of 5.5 in accordance with an embodiment;

FIG. 9 is an illustrative plot of two bands in wavelet space with a wavelet transform computed at an ωₒ of 12.5 in accordance with an embodiment; and

FIG. 10 is an illustrative plot of two bands in wavelet space with a wavelet transform computed at an ωₒ of 5.5 and at an ωₒ of 12.5 in accordance with an embodiment.

### DETAILED DESCRIPTION

An oximeter is a medical device that may determine the oxygen saturation of the blood. One common type of oximeter is a pulse oximeter, which may indirectly measure the oxygen saturation of a patient's blood (as opposed to measuring oxygen saturation directly by analyzing a blood sample taken from the patient) and changes in blood volume in the skin. Ancillary to the blood oxygen saturation measurement, pulse oximeters may also be used to measure the pulse rate of the patient. Pulse oximeters typically measure and display various blood flow characteristics including, but not limited to, the oxygen saturation of hemoglobin in arterial blood.

An oximeter may include a light sensor that is placed at a site on a patient, typically a fingertip, toe, forehead or earlobe, or in the case of a neonate, across a foot. The oximeter may pass light using a light source through blood perfused tissue and photoelectrically sense the absorption of light in the tissue. For example, the oximeter may measure the intensity of light that is received at the light sensor as a function of time. A signal representing light intensity versus time or a mathematical manipulation of this signal (e.g., a scaled version thereof, a log taken thereof, a scaled version of a log taken thereof, etc.) may be referred to as the photoplethysmograph (PPG) signal. In addition, the term “PPG signal,” as used herein, may also refer to an absorption signal (i.e., representing the amount of light absorbed by the tissue) or any suitable mathematical manipulation thereof. The light intensity or the amount of light absorbed may then be used to calculate the amount of the blood constituent (e.g., oxyhemoglobin) being measured as well as the pulse rate and when each individual pulse occurs.

The light passed through the tissue is selected to be of one or more wavelengths that are absorbed by the blood in an amount representative of the amount of the blood constituent present in the blood. The amount of light passed through the tissue varies in accordance with the changing amount of blood constituent in the tissue and the related light absorption. Red and infrared wavelengths may be used because it has been observed that highly oxygenated blood will absorb relatively less red light and more infrared light than blood with a lower oxygen saturation. By comparing the intensities of two wavelengths at different points in the pulse cycle, it is possible to estimate the blood oxygen saturation of hemoglobin in arterial blood.

When the measured blood parameter is the oxygen saturation of hemoglobin, a convenient starting point assumes a saturation calculation based on Lambert-Beer's law. The following notation will be used herein:

I(λ,t)=Iₒ(λ)exp(−(sβₒ(λ)+(1−s)βᵣ(λ))l(t)) (1)

where:
λ=wavelength;
t=time;
I=intensity of light detected;
Iₒ=intensity of light transmitted;
s=oxygen saturation;
βₒ, βᵣ=empirically derived absorption coefficients; and
l(t)=a combination of concentration and path length from emitter to detector as a function of time.

The traditional approach measures light absorption at two wavelengths (e.g., red and infrared (IR)), and then calculates saturation by solving for the “ratio of ratios” as follows.

1. First, the natural logarithm of (1) is taken (“log” will be used to represent the natural logarithm) for IR and Red

log I=log Iₒ−(sβₒ+(1−s)βᵣ)l (2)

2. (2) is then differentiated with respect to time

$$\frac{d log I}{d t} = - ( s {β}_{o} + ( 1 - s ) {β}_{r} ) \frac{d l}{d t} \qquad ( 3 )$$

3. Red (3) is divided by IR (3)

$$\frac{d log I ( {λ}_{R} ) / d t}{d log I ( {λ}_{IR} ) / d t} = \frac{s {β}_{o} ( {λ}_{R} ) + ( 1 - s ) {β}_{r} ( {λ}_{R} )}{s {β}_{o} ( {λ}_{IR} ) + ( 1 - s ) {β}_{r} ( {λ}_{IR} )} \qquad ( 4 )$$

### 4. Solving for s

$$s = \frac{\frac{d log I ( {λ}_{IR} )}{d t} {β}_{r} ( {λ}_{R} ) - \frac{d log I ( {λ}_{R} )}{d t} {β}_{r} ( {λ}_{IR} )}{\frac{d log I ( {λ}_{R} )}{d t} ( {β}_{o} ( {λ}_{IR} ) - {β}_{r} ( {λ}_{IR} ) ) - \frac{d log I ( {λ}_{IR} )}{d t} ( {β}_{o} ( {λ}_{R} ) - {β}_{r} ( {λ}_{R} ) )}$$

Note in discrete time

$$\frac{d log I ( λ , t )}{d t} ≃ log I ( λ , {t}_{2} ) - log I ( λ , {t}_{1} )$$

### Using log A−log B=log A/B,

$$\frac{d log I ( λ , t )}{d t} ≃ log ( \frac{I ( {t}_{2} , λ )}{I ( {t}_{1} , λ )} )$$

So, (4) can be rewritten as

$$\frac{d log I ( {λ}_{R} )}{\frac{d t}{\frac{d log I ( {λ}_{IR} )}{d t}}} ≃ \frac{log ( \frac{I ( {t}_{1} , {λ}_{R} )}{I ( {t}_{2} , {λ}_{R} )} )}{log ( \frac{I ( {t}_{1} , {λ}_{IR} )}{I ( {t}_{2} , {λ}_{IR} )} )} = R \qquad ( 5 )$$

where R represents the “ratio of ratios.” Solving (4) for s using (5) gives

$$s = \frac{{β}_{r} ( {λ}_{R} ) - R {β}_{r} ( {λ}_{IR} )}{R ( {β}_{o} ( {λ}_{IR} ) - {β}_{r} ( {λ}_{IR} ) ) - {β}_{o} ( {λ}_{R} ) + {β}_{r} ( {λ}_{R} )} .$$

From (5), R can be calculated using two points (e.g., PPG maximum and minimum), or a family of points. One method using a family of points uses a modified version of (5). Using the relationship

$$\frac{d log I}{d t} = \frac{d I / d t}{I} \qquad ( 6 )$$

now (5) becomes

$$\begin{matrix}\frac{d log I ( {λ}_{R} )}{\frac{d t}{\frac{d log I ( {λ}_{IR} )}{d t}}} ≃ \frac{I ( {t}_{2} , {λ}_{R} ) - I ( {t}_{1} , {λ}_{R} )}{\frac{I ( {t}_{1} , {λ}_{R} )}{\frac{I ( {t}_{2} , {λ}_{IR} ) - I ( {t}_{1} , {λ}_{IR} )}{I ( {t}_{1} , {λ}_{IR} )}}} \\ = \frac{[ I ( {t}_{2} , {λ}_{R} ) - I ( {t}_{1} , {λ}_{R} ) ] I ( {t}_{1} , {λ}_{IR} )}{[ I ( {t}_{2} , {λ}_{IR} ) - I ( {t}_{1} , {λ}_{IR} ) ] I ( {t}_{1} , {λ}_{R} )} \\ = R\end{matrix} \qquad ( 7 )$$

which defines a cluster of points whose slope of y versus x will give R where

x(t)=[I(t₂,λ_{IR})−I(t₁,λ_{IR})]I(t₁,λ_{R})

y(t)=[I(t₂,λ_{R})−I(t₁,λ_{R})]I(t₁,λ_{IR})

y(t)=Rx(t) (8)

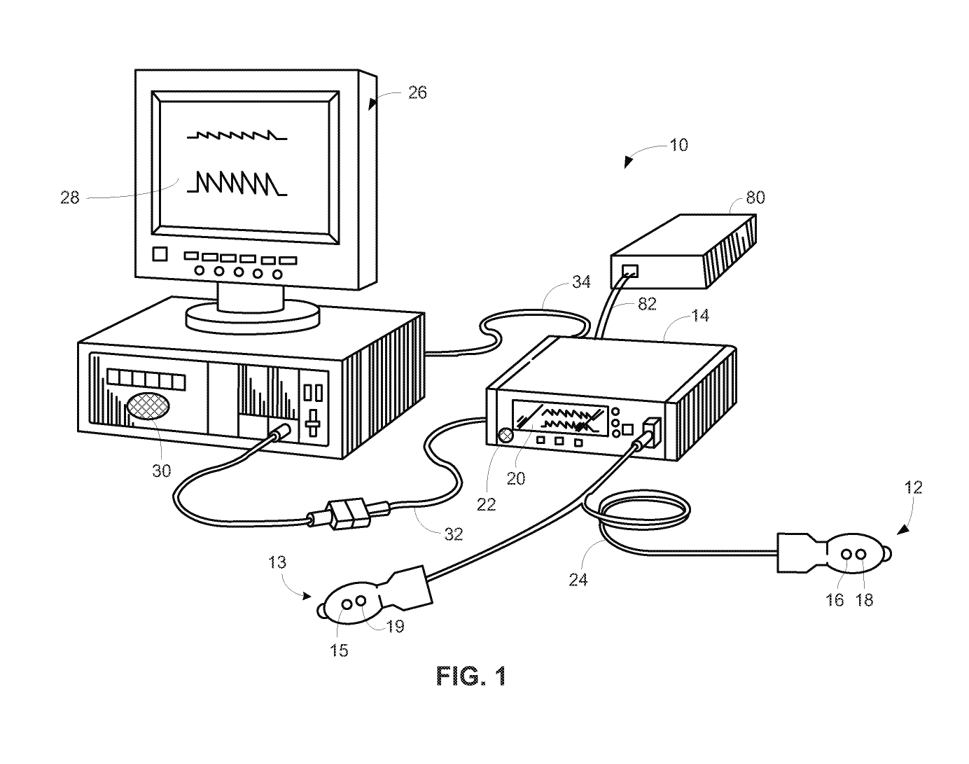

FIG. 1 is a perspective view of an embodiment of a pulse oximetry system 10. System 10 may include a sensor 12 and a pulse oximetry monitor 14. Sensor 12 may include an emitter 16 for emitting light at two or more wavelengths into a patient's tissue. A detector 18 may also be provided in sensor 12 for detecting the light originally from emitter 16 that emanates from the patient's tissue after passing through the tissue.

According to another embodiment and as will be described, system 10 may include a plurality of sensors forming a sensor array in lieu of single sensor 12. Each of the sensors of the sensor array may be a complementary metal oxide semiconductor (CMOS) sensor. Alternatively, each sensor of the array may be charged coupled device (CCD) sensor. In another embodiment, the sensor array may be made up of a combination of CMOS and CCD sensors. The CCD sensor may comprise a photoactive region and a transmission region for receiving and transmitting data whereas the CMOS sensor may be made up of an integrated circuit having an array of pixel sensors. Each pixel may have a photodetector and an active amplifier.

According to an embodiment, emitter 16 and detector 18 may be on opposite sides of a digit such as a finger or toe, in which case the light that is emanating from the tissue has passed completely through the digit. In an embodiment, emitter 16 and detector 18 may be arranged so that light from emitter 16 penetrates the tissue and is reflected by the tissue into detector 18, such as a sensor designed to obtain pulse oximetry data from a patient's forehead.

In an embodiment, the sensor or sensor array may be connected to and draw its power from monitor 14 as shown. In another embodiment, the sensor may be wirelessly connected to monitor 14 and include its own battery or similar power supply (not shown). Monitor 14 may be configured to calculate physiological parameters based at least in part on data received from sensor 12 relating to light emission and detection. In an alternative embodiment, the calculations may be performed on the monitoring device itself and the result of the oximetry reading may be passed to monitor 14. Further, monitor 14 may include a display 20 configured to display the physiological parameters or other information about the system. In the embodiment shown, monitor 14 may also include a speaker 22 to provide an audible sound that may be used in various other embodiments, such as for example, sounding an audible alarm in the event that a patient's physiological parameters are not within a predefined normal range.

In an embodiment, sensor 12, or the sensor array, may be communicatively coupled to monitor 14 via a cable 24. However, in other embodiments, a wireless transmission device (not shown) or the like may be used instead of or in addition to cable 24.

In the illustrated embodiment, pulse oximetry system 10 may also include a multi-parameter patient monitor 26. The monitor may be cathode ray tube type, a flat panel display (as shown) such as a liquid crystal display (LCD) or a plasma display, or any other type of monitor now known or later developed. Multi-parameter patient monitor 26 may be configured to calculate physiological parameters and to provide a display 28 for information from monitor 14 and from other medical monitoring devices or systems (not shown). For example, multi-parameter patient monitor 26 may be configured to display an estimate of a patient's blood oxygen saturation generated by pulse oximetry monitor 14 (referred to as an “SpO₂” measurement), pulse rate information from monitor 14 and blood pressure from a blood pressure monitor (not shown) on display 28.

Monitor 14 may be communicatively coupled to multi-parameter patient monitor 26 via a cable 32 or 34 that is coupled to a sensor input port or a digital communications port, respectively and/or may communicate wirelessly (not shown). In addition, monitor 14 and/or multi-parameter patient monitor 26 may be coupled to a network to enable the sharing of information with servers or other workstations (not shown). Monitor 14 may be powered by a battery (not shown) or by a conventional power source such as a wall outlet.

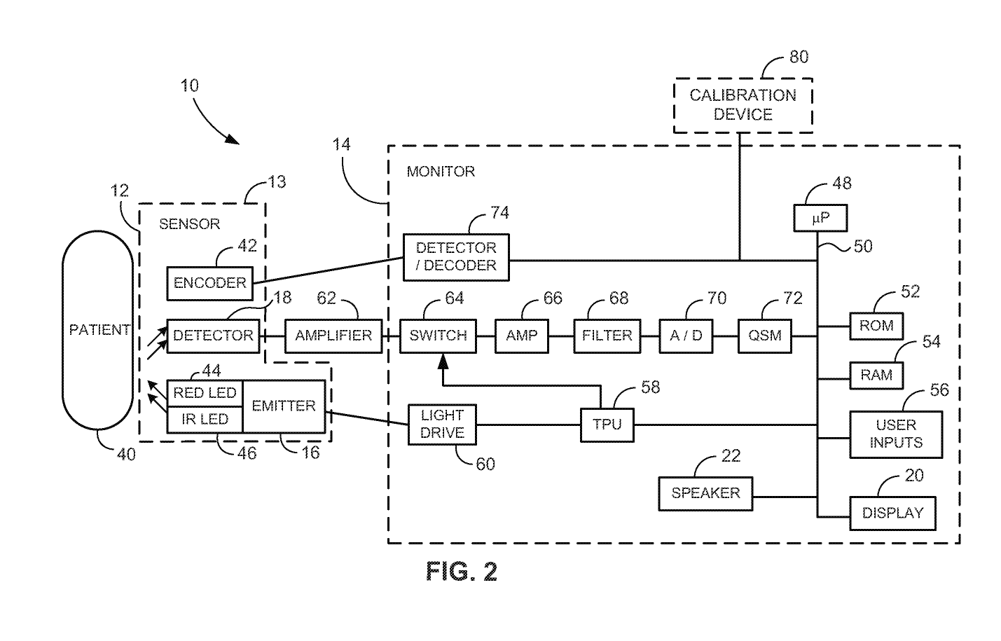

FIG. 2 is a block diagram of a pulse oximetry system, such as pulse oximetry system 10 of FIG. 1, which may be coupled to a patient 40 in accordance with an embodiment. Certain illustrative components of sensor 12 and monitor 14 are illustrated in FIG. 2. Sensor 12 may include emitter 16, detector 18, and encoder 42. In the embodiment shown, emitter 16 may be configured to emit at least two wavelengths of light (e.g., RED and IR) into a patient's tissue 40. Hence, emitter 16 may include a RED light emitting light source such as RED light emitting diode (LED) 44 and an IR light emitting light source such as JR LED 46 for emitting light into the patient's tissue 40 at the wavelengths used to calculate the patient's physiological parameters. In one embodiment, the RED wavelength may be between about 600 nm and about 700 nm, and the IR wavelength may be between about 800 nm and about 1000 nm. In embodiments where a sensor array is used in place of single sensor, each sensor may be configured to emit a single wavelength. For example, a first sensor emits only a RED light while a second only emits an JR light.

It will be understood that, as used herein, the term “light” may refer to energy produced by radiative sources and may include one or more of ultrasound, radio, microwave, millimeter wave, infrared, visible, ultraviolet, gamma ray or X-ray electromagnetic radiation. As used herein, light may also include any wavelength within the radio, microwave, infrared, visible, ultraviolet, or X-ray spectra, and that any suitable wavelength of electromagnetic radiation may be appropriate for use with the present techniques. Detector 18 may be chosen to be specifically sensitive to the chosen targeted energy spectrum of the emitter 16.

In an embodiment, detector 18 may be configured to detect the intensity of light at the RED and IR wavelengths. Alternatively, each sensor in the array may be configured to detect an intensity of a single wavelength. In operation, light may enter detector 18 after passing through the patient's tissue 40. Detector 18 may convert the intensity of the received light into an electrical signal. The light intensity is directly related to the absorbance and/or reflectance of light in the tissue 40. That is, when more light at a certain wavelength is absorbed or reflected, less light of that wavelength is received from the tissue by the detector 18. After converting the received light to an electrical signal, detector 18 may send the signal to monitor 14, where physiological parameters may be calculated based on the absorption of the RED and IR wavelengths in the patient's tissue 40.

In an embodiment, encoder 42 may contain information about sensor 12, such as what type of sensor it is (e.g., whether the sensor is intended for placement on a forehead or digit) and the wavelengths of light emitted by emitter 16. This information may be used by monitor 14 to select appropriate algorithms, lookup tables and/or calibration coefficients stored in monitor 14 for calculating the patient's physiological parameters.

Encoder 42 may contain information specific to patient 40, such as, for example, the patient's age, weight, and diagnosis. This information may allow monitor 14 to determine, for example, patient-specific threshold ranges in which the patient's physiological parameter measurements should fall and to enable or disable additional physiological parameter algorithms. Encoder 42 may, for instance, be a coded resistor which stores values corresponding to the type of sensor 12 or the type of each sensor in the sensor array, the wavelengths of light emitted by emitter 16 on each sensor of the sensor array, and/or the patient's characteristics. In another embodiment, encoder 42 may include a memory on which one or more of the following information may be stored for communication to monitor 14: the type of the sensor 12; the wavelengths of light emitted by emitter 16; the particular wavelength each sensor in the sensor array is monitoring; a signal threshold for each sensor in the sensor array; any other suitable information; or any combination thereof.

In an embodiment, signals from detector 18 and encoder 42 may be transmitted to monitor 14. In the embodiment shown, monitor 14 may include a general-purpose microprocessor 48 connected to an internal bus 50. Microprocessor 48 may be adapted to execute software, which may include an operating system and one or more applications, as part of performing the functions described herein. Also connected to bus 50 may be a read-only memory (ROM) 52, a random access memory (RAM) 54, user inputs 56, display 20, and speaker 22.

RAM 54 and ROM 52 are illustrated by way of example, and not limitation. Any suitable computer-readable media may be used in the system for data storage. Computer-readable media are capable of storing information that can be interpreted by microprocessor 48. This information may be data or may take the form of computer-executable instructions, such as software applications, that cause the microprocessor to perform certain functions and/or computer-implemented methods. Depending on the embodiment, such computer-readable media may include computer storage media and communication media. Computer storage media may include volatile and non-volatile, removable and non-removable media implemented in any method or technology for storage of information such as computer-readable instructions, data structures, program modules or other data. Computer storage media may include, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by components of the system.

In the embodiment shown, a time processing unit (TPU) 58 may provide timing control signals to a light drive circuitry 60, which may control when emitter 16 is illuminated and multiplexed timing for the RED LED 44 and the IR LED 46. TPU 58 may also control the gating-in of signals from detector 18 through an amplifier 62 and a switching circuit 64. These signals are sampled at the proper time, depending upon which light source is illuminated. The received signal from detector 18 may be passed through an amplifier 66, a low pass filter 68, and an analog-to-digital converter 70. The digital data may then be stored in a queued serial module (QSM) 72 (or buffer) for later downloading to RAM 54 as QSM 72 fills up. In one embodiment, there may be multiple separate parallel paths having amplifier 66, filter 68, and A/D converter 70 for multiple light wavelengths or spectra received.

In an embodiment, microprocessor 48 may determine the patient's physiological parameters, such as SpO₂ and pulse rate, using various algorithms and/or look-up tables based on the value of the received signals and/or data corresponding to the light received by detector 18. In an embodiment, microprocessor 48 may be used for signal processing. For example, microprocessor 48 may tune a wavelet transform to a particular characteristic frequency in a scale band of interest. Signals corresponding to information about patient 40, and particularly about the intensity of light emanating from a patient's tissue over time, may be transmitted from encoder 42 to a decoder 74. These signals may include, for example, encoded information relating to patient characteristics. Decoder 74 may translate these signals to enable the microprocessor to determine the thresholds based on algorithms or look-up tables stored in ROM 52. User inputs 56 may be used to enter information about the patient, such as age, weight, height, diagnosis, medications, treatments, and so forth. In an embodiment, display 20 may exhibit a list of values which may generally apply to the patient, such as, for example, age ranges or medication families, which the user may select using user inputs 56.

The optical signal through the tissue can be degraded by noise, among other sources. One source of noise is ambient light that reaches the light detector. Another source of noise is electromagnetic coupling from other electronic instruments. Movement of the patient also introduces noise and affects the signal. For example, the contact between the detector and the skin, or the emitter and the skin, can be temporarily disrupted when movement causes either to move away from the skin. In addition, because blood is a fluid, it responds differently than the surrounding tissue to inertial effects, thus resulting in momentary changes in volume at the point to which the oximeter probe is attached.

Noise (e.g., from patient movement) can degrade a pulse oximetry signal relied upon by a physician, without the physician's awareness. This is especially true if the monitoring of the patient is remote, the motion is too small to be observed, or the doctor is watching the instrument or other parts of the patient, and not the sensor site. Processing pulse oximetry (i.e., PPG) signals may involve operations that reduce the amount of noise present in the signals or otherwise identify noise components in order to prevent them from affecting measurements of physiological parameters derived from the PPG signals.

It will be understood that the present disclosure is applicable to any suitable signals and that PPG signals are used merely for illustrative purposes. Those skilled in the art will recognize that the present disclosure has wide applicability to other signals including, but not limited to other biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In one embodiment, a PPG signal may be transformed using a continuous wavelet transform. Information derived from the transform of the PPG signal (i.e., in wavelet space) may be used to provide measurements of one or more physiological parameters.

The continuous wavelet transform of a signal x(t) in accordance with the present disclosure may be defined as

$$T ( a , b ) = \frac{1}{\sqrt{a}} {\int }_{- ∞}^{+ ∞} x ( t ) {ψ}^{*} ( \frac{t - b}{a} ) d t \qquad ( 9 )$$

where ψ*(t) is the complex conjugate of the wavelet function ψ(t), a is the dilation parameter of the wavelet and b is the location parameter of the wavelet. The transform given by equation (9) may be used to construct a representation of a signal on a transform surface. The transform may be regarded as a time-scale representation. Wavelets are composed of a range of frequencies, one of which may be denoted as the characteristic frequency of the wavelet, where the characteristic frequency associated with the wavelet is inversely proportional to the scale a. One example of a characteristic frequency is the dominant frequency. Each scale of a particular wavelet may have a different characteristic frequency. The underlying mathematical detail required for the implementation within a time-scale can be found, for example, in Paul S. Addison, The Illustrated Wavelet Transform Handbook (Taylor & Francis Group 2002), which is hereby incorporated by reference herein in its entirety.

The continuous wavelet transform decomposes a signal using wavelets, which are generally highly localized in time. The continuous wavelet transform may provide a higher resolution relative to discrete transforms, thus providing the ability to garner more information from signals than typical frequency transforms such as Fourier transforms (or any other spectral techniques) or discrete wavelet transforms. Continuous wavelet transforms allow for the use of a range of wavelets with scales spanning the scales of interest of a signal such that small scale signal components correlate well with the smaller scale wavelets and thus manifest at high energies at smaller scales in the transform. Likewise, large scale signal components correlate well with the larger scale wavelets and thus manifest at high energies at larger scales in the transform. Thus, components at different scales may be separated and extracted in the wavelet transform domain. Moreover, the use of a continuous range of wavelets in scale and time position allows for a higher resolution transform than is possible relative to discrete techniques.

In addition, transforms and operations that convert a signal or any other type of data into a spectral (i.e., frequency) domain necessarily create a series of frequency transform values in a two-dimensional coordinate system where the two dimensions may be frequency and, for example, amplitude. For example, any type of Fourier transform would generate such a two-dimensional spectrum. In contrast, wavelet transforms, such as continuous wavelet transforms, are required to be defined in a three-dimensional coordinate system and generate a surface with dimensions of time, scale and, for example, amplitude. Hence, operations performed in a spectral domain cannot be performed in the wavelet domain; instead the wavelet surface must be transformed into a spectrum (i.e., by performing an inverse wavelet transform to convert the wavelet surface into the time domain and then performing a spectral transform from the time domain). Conversely, operations performed in the wavelet domain cannot be performed in the spectral domain; instead a spectrum must first be transformed into a wavelet surface (i.e., by performing an inverse spectral transform to convert the spectral domain into the time domain and then performing a wavelet transform from the time domain). Nor does a cross-section of the three-dimensional wavelet surface along, for example, a particular point in time equate to a frequency spectrum upon which spectral-based techniques may be used. At least because wavelet space includes a time dimension, spectral techniques and wavelet techniques are not interchangeable. It will be understood that converting a system that relies on spectral domain processing to one that relies on wavelet space processing would require significant and fundamental modifications to the system in order to accommodate the wavelet space processing (e.g., to derive a representative energy value for a signal or part of a signal requires integrating twice, across time and scale, in the wavelet domain while, conversely, one integration across frequency is required to derive a representative energy value from a spectral domain). As a further example, to reconstruct a temporal signal requires integrating twice, across time and scale, in the wavelet domain while, conversely, one integration across frequency is required to derive a temporal signal from a spectral domain. It is well known in the art that, in addition to or as an alternative to amplitude, parameters such as energy density, modulus, phase, among others may all be generated using such transforms and that these parameters have distinctly different contexts and meanings when defined in a two-dimensional frequency coordinate system rather than a three-dimensional wavelet coordinate system. For example, the phase of a Fourier system is calculated with respect to a single origin for all frequencies while the phase for a wavelet system is unfolded into two dimensions with respect to a wavelet's location (often in time) and scale.

The energy density function of the wavelet transform, the scalogram, is defined as

S(a,b)=|T(a,b)|² (10)

where ‘∥’ is the modulus operator. The scalogram may be resealed for useful purposes. One common resealing is defined as

$${S}_{R} ( a , b ) = \frac{{\vert T ( a , b ) \vert}^{2}}{a} \qquad ( 11 )$$

and is useful for defining ridges in wavelet space when, for example, the Morlet wavelet is used. Ridges are defined as the locus of points of local maxima in the plane. Any reasonable definition of a ridge may be employed in the method. Also included as a definition of a ridge herein are paths displaced from the locus of the local maxima. A ridge associated with only the locus of points of local maxima in the plane are labeled a “maxima ridge”.

For implementations requiring fast numerical computation, the wavelet transform may be expressed as an approximation using Fourier transforms. Pursuant to the convolution theorem, because the wavelet transform is the cross-correlation of the signal with the wavelet function, the wavelet transform may be approximated in terms of an inverse FFT of the product of the Fourier transform of the signal and the Fourier transform of the wavelet for each required a scale and then multiplying the result by \sqrt{a}.

In the discussion of the technology which follows herein, the “scalogram” may be taken to include all suitable forms of resealing including, but not limited to, the original unsealed wavelet representation, linear resealing, any power of the modulus of the wavelet transform, or any other suitable resealing. In addition, for purposes of clarity and conciseness, the term “scalogram” shall be taken to mean the wavelet transform, T(a,b) itself, or any part thereof. For example, the real part of the wavelet transform, the imaginary part of the wavelet transform, the phase of the wavelet transform, any other suitable part of the wavelet transform, or any combination thereof is intended to be conveyed by the term “scalogram”.

A scale, which may be interpreted as a representative temporal period, may be converted to a characteristic frequency of the wavelet function. The characteristic frequency associated with a wavelet of arbitrary a scale is given by

$$f = \frac{{f}_{c}}{a} \qquad ( 12 )$$

where f_{c}, the characteristic frequency of the mother wavelet (i.e., at a=1), becomes a scaling constant and f is the representative or characteristic frequency for the wavelet at arbitrary scale a.

Any suitable wavelet function may be used in connection with the present disclosure. One of the most commonly used complex wavelets, the Morlet wavelet, is defined as:

ψ(t)=π^{-1/4}(e^{i2πf}^{₀}^{t}−e^{-(2πf}^{₀}⁾^{²}^{/2})e^{-t}^{²}^{/2} (13)

where f₀ is the central frequency of the mother wavelet. The second term in the parenthesis is known as the correction term, as it corrects for the non-zero mean of the complex sinusoid within the Gaussian window. In practice, it becomes negligible for values of f₀>>0 and can be ignored, in which case, the Morlet wavelet can be written in a simpler form as

$$ψ ( t ) = \frac{1}{{π}^{1 / 4}} {e}^{i 2 π {f}_{0} t} {e}^{- {t}^{2} / 2} \qquad ( 14 )$$

This wavelet is a complex wave within a scaled Gaussian envelope. While both definitions of the Morlet wavelet are included herein, the function of equation (14) is not strictly a wavelet as it has a non-zero mean (i.e., the zero frequency term of its corresponding energy spectrum is non-zero). However, it will be recognized by those skilled in the art that equation (14) may be used in practice with f₀>>0 with minimal error and is included (as well as other similar near wavelet functions) in the definition of a wavelet herein. A more detailed overview of the underlying wavelet theory, including the definition of a wavelet function, can be found in the general literature. Discussed herein is how wavelet transform features may be extracted from the wavelet decomposition of signals. For example, wavelet decomposition of PPG signals may be used to provide clinically useful information within a medical device.

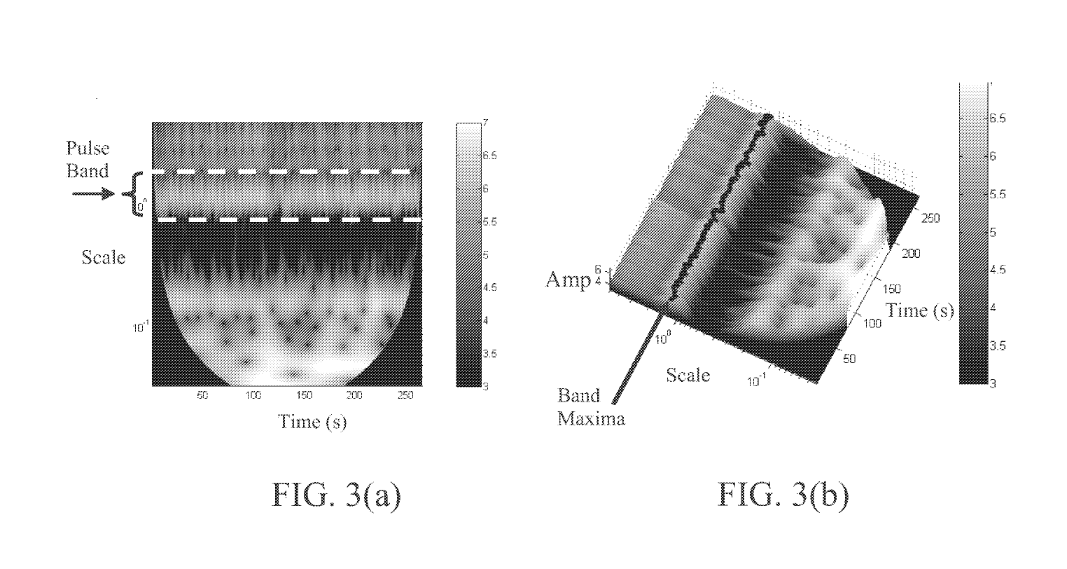

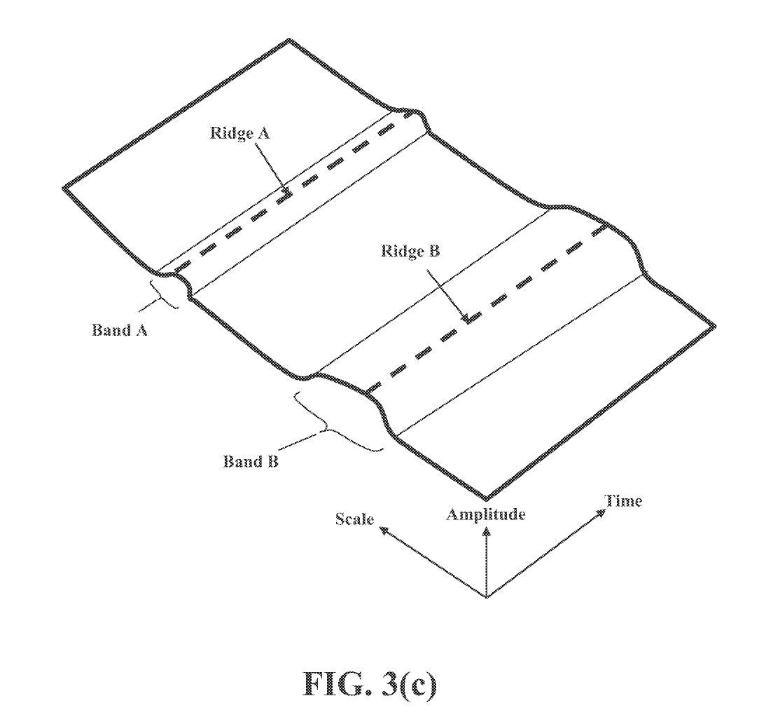

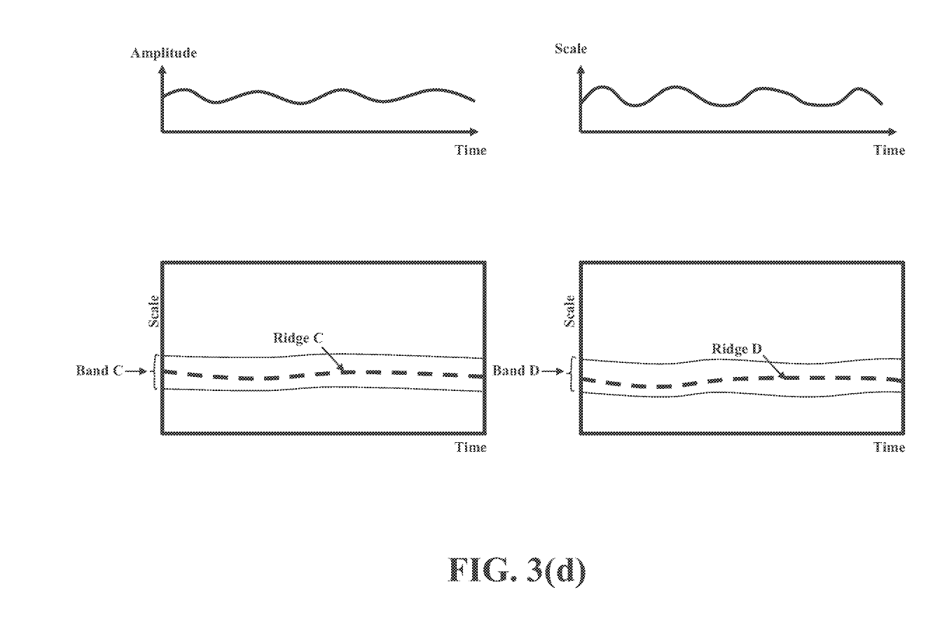

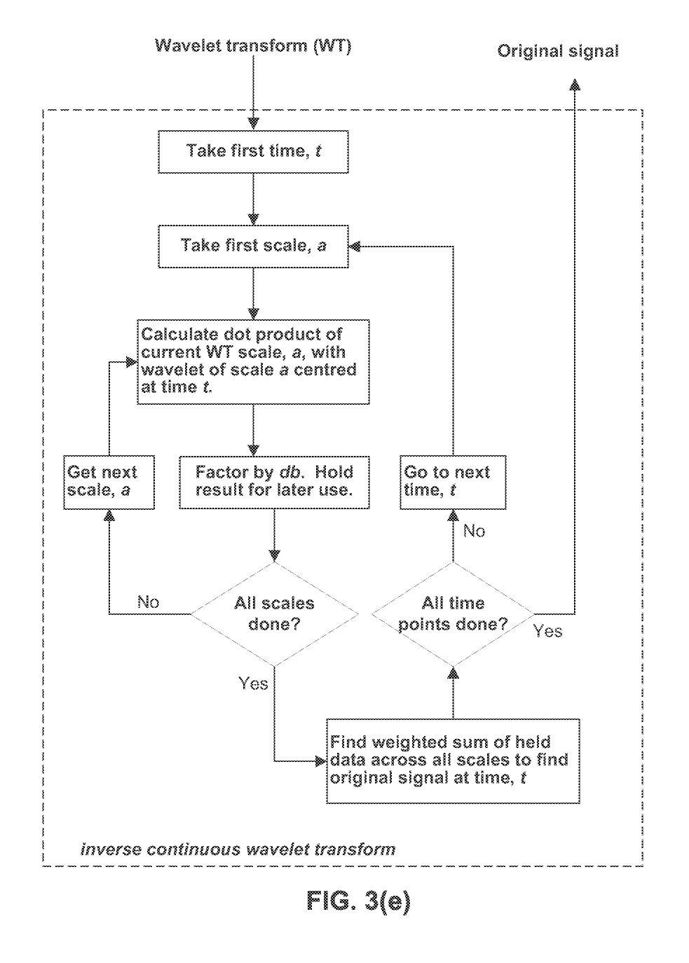

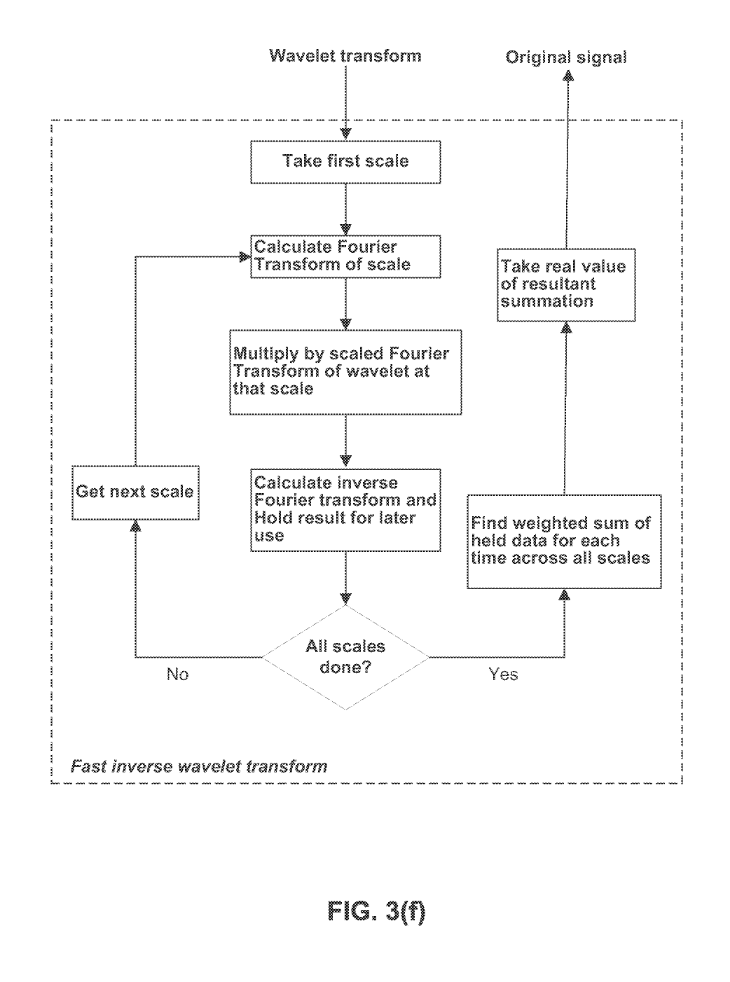

Pertinent repeating features in a signal give rise to a time-scale band in wavelet space or a resealed wavelet space. For example, the pulse component of a PPG signal produces a dominant band in wavelet space at or around the pulse frequency. FIGS. 3(a) and (b) show two views of an illustrative scalogram derived from a PPG signal, according to an embodiment. The figures show an example of the band caused by the pulse component in such a signal. The pulse band is located between the dashed lines in the plot of FIG. 3(a). The band is formed from a series of dominant coalescing features across the scalogram. This can be clearly seen as a raised band across the transform surface in FIG. 3(b) located within the region of scales indicated by the arrow in the plot (corresponding to 60 beats per minute). The maxima of this band with respect to scale is the ridge. The locus of the ridge is shown as a black curve on top of the band in FIG. 3(b). By employing a suitable resealing of the scalogram, such as that given in equation (11), the ridges found in wavelet space may be related to the instantaneous frequency of the signal. In this way, the pulse rate may be obtained from the PPG signal. Instead of resealing the scalogram, a suitable predefined relationship between the scale obtained from the ridge on the wavelet surface and the actual pulse rate may also be used to determine the pulse rate.

By mapping the time-scale coordinates of the pulse ridge onto the wavelet phase information gained through the wavelet transform, individual pulses may be captured. In this way, both times between individual pulses and the timing of components within each pulse may be monitored and used to detect heart beat anomalies, measure arterial system compliance, or perform any other suitable calculations or diagnostics. Alternative definitions of a ridge may be employed. Alternative relationships between the ridge and the pulse frequency of occurrence may be employed. As discussed below, the wavelet transform may be tuned to a separate characteristic frequency in the location of each ridge.

As discussed above, pertinent repeating features in the signal give rise to a time-scale band in wavelet space or a resealed wavelet space. For a periodic signal, this band remains at a constant scale in the time-scale plane. For many real signals, especially biological signals, the band may be non-stationary; varying in scale, amplitude, or both over time. FIG. 3(c) shows an illustrative schematic of a wavelet transform of a signal containing two pertinent components leading to two bands in the transform space, according to an embodiment. These bands are labeled band A and band B on the three-dimensional schematic of the wavelet surface. In this embodiment, the band ridge is defined as the locus of the peak values of these bands with respect to scale. For purposes of discussion, it may be assumed that band B contains the signal information of interest. This will be referred to as the “primary band”. In addition, it may be assumed that the system from which the signal originates, and from which the transform is subsequently derived, exhibits some form of coupling between the signal components in band A and band B. When noise or other erroneous features are present in the signal with similar spectral characteristics of the features of band B then the information within band B can become ambiguous (i.e., obscured, fragmented or missing). In this case, the ridge of band A may be followed in wavelet space and extracted either as an amplitude signal or a scale signal which will be referred to as the “ridge amplitude perturbation” (RAP) signal and the “ridge scale perturbation” (RSP) signal, respectively. The RAP and RSP signals may be extracted by projecting the ridge onto the time-amplitude or time-scale planes, respectively. The top plots of FIG. 3(d) show a schematic of the RAP and RSP signals associated with ridge A in FIG. 3(c). Below these RAP and RSP signals are schematics of a further wavelet decomposition of these newly derived signals. This secondary wavelet decomposition allows for information in the region of band B in FIG. 3(c) to be made available as band C and band D. The ridges of bands C and D may serve as instantaneous time-scale characteristic measures of the signal components causing bands C and D. This technique, which will be referred to herein as secondary wavelet feature decoupling (SWFD), may allow information concerning the nature of the signal components associated with the underlying physical process causing the primary band B (FIG. 3(c)) to be extracted when band B itself is obscured in the presence of noise or other erroneous signal features.

In some instances, an inverse continuous wavelet transform may be desired, such as when modifications to a scalogram (or modifications to the coefficients of a transformed signal) have been made in order to, for example, remove artifacts. In one embodiment, there is an inverse continuous wavelet transform which allows the original signal to be recovered from its wavelet transform by integrating over all scales and locations, a and b:

$$x ( t ) = \frac{1}{{C}_{g}} {\int }_{- ∞}^{∞} {\int }_{0}^{∞} T ( a , b ) \frac{1}{\sqrt{a}} Ψ ( \frac{t - b}{a} ) \frac{d a d b}{{a}^{2}} \qquad ( 15 )$$

which may also be written as:

$$x ( t ) = \frac{1}{{C}_{g}} {\int }_{- ∞}^{∞} {\int }_{0}^{∞} T ( a , b ) {Ψ}_{a , b} ( t ) \frac{d a d b}{{a}^{2}} \qquad ( 16 )$$

where C_{g} is a scalar value known as the admissibility constant. It is wavelet type dependent and may be calculated from:

$${C}_{g} = {\int }_{0}^{∞} \frac{{\vert \hat{ψ} ( f ) \vert}^{2}}{f} d f \qquad ( 17 )$$

FIG. 3(e) is a flow chart of illustrative steps that may be taken to perform an inverse continuous wavelet transform in accordance with the above discussion. An approximation to the inverse transform may be made by considering equation (15) to be a series of convolutions across scales. It shall be understood that there is no complex conjugate here, unlike for the cross correlations of the forward transform. As well as integrating over all of a and b for each time t, this equation may also take advantage of the convolution theorem which allows the inverse wavelet transform to be executed using a series of multiplications. FIG. 3(f) is a flow chart of illustrative steps that may be taken to perform an approximation of an inverse continuous wavelet transform. It will be understood that any other suitable technique for performing an inverse continuous wavelet transform may be used in accordance with the present disclosure.

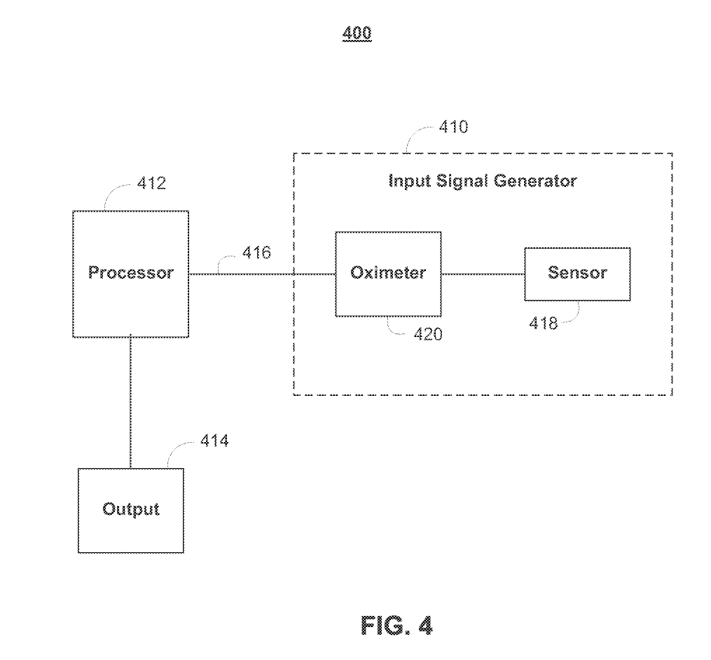

FIG. 4 is an illustrative continuous wavelet processing system in accordance with an embodiment. In this embodiment, input signal generator 410 generates an input signal 416. As illustrated, input signal generator 410 may include oximeter 420 coupled to sensor 418, which may provide as input signal 416, a PPG signal. It will be understood that input signal generator 410 may include any suitable signal source, signal generating data, signal generating equipment, or any combination thereof to produce signal 416. Signal 416 may be any suitable signal or signals, such as, for example, biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In this embodiment, signal 416 may be coupled to processor 412. Processor 412 may be any suitable software, firmware, and/or hardware, and/or combinations thereof for processing signal 416. For example, processor 412 may include one or more hardware processors (e.g., integrated circuits), one or more software modules, computer-readable media such as memory, firmware, or any combination thereof. Processor 412 may, for example, be a computer or may be one or more chips (i.e., integrated circuits). Processor 412 may perform the calculations associated with the continuous wavelet transforms of the present disclosure as well as the calculations associated with any suitable interrogations of the transforms. Processor 412 may perform any suitable signal processing of signal 416 to filter signal 416, such as any suitable band-pass filtering, adaptive filtering, closed-loop filtering, and/or any other suitable filtering, and/or any combination thereof. Processor 416 may perform any suitable computation for signal analysis. For example, processor 416 may be capable of tuning a wavelet transform. In an embodiment, processor 416 tunes the wavelet transform to a particular characteristic frequency to produce better definition in the wavelet transform for repeating signal features.

Processor 412 may be coupled to one or more memory devices (not shown) or incorporate one or more memory devices such as any suitable volatile memory device (e.g., RAM, registers, etc.), non-volatile memory device (e.g., ROM, EPROM, magnetic storage device, optical storage device, flash memory, etc.), or both. The memory may be used by processor 412 to, for example, store data corresponding to a continuous wavelet transform of input signal 416, such as data representing a scalogram. In one embodiment, data representing a scalogram may be stored in RAM or memory internal to processor 412 as any suitable three-dimensional data structure such as a three-dimensional array that represents the scalogram as energy levels in a time-scale plane. Any other suitable data structure may be used to store data representing a scalogram.

Processor 412 may be coupled to output 414. Output 414 may be any suitable output device such as, for example, one or more medical devices (e.g., a medical monitor that displays various physiological parameters, a medical alarm, or any other suitable medical device that either displays physiological parameters or uses the output of processor 412 as an input), one or more display devices (e.g., monitor, PDA, mobile phone, any other suitable display device, or any combination thereof), one or more audio devices, one or more memory devices (e.g., hard disk drive, flash memory, RAM, optical disk, any other suitable memory device, or any combination thereof), one or more printing devices, any other suitable output device, or any combination thereof.

It will be understood that system 400 may be incorporated into system 10 (FIGS. 1 and 2) in which, for example, input signal generator 410 may be implemented as parts of sensor 12 and monitor 14 and processor 412 may be implemented as part of monitor 14.

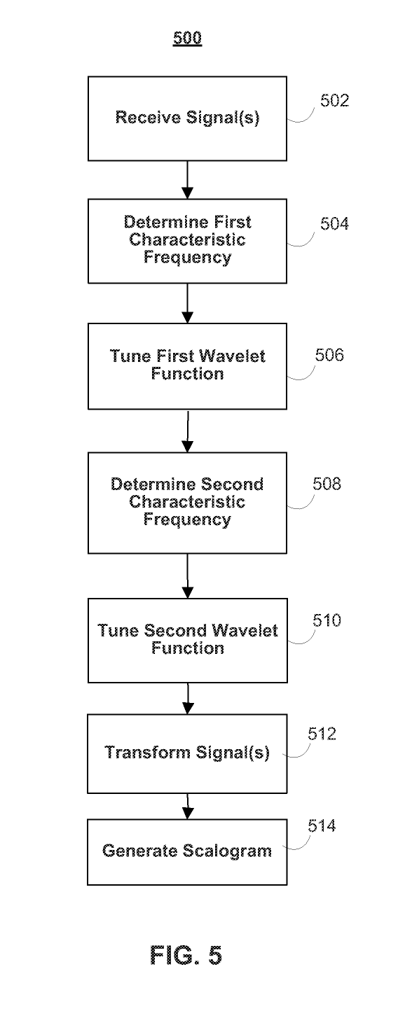

FIG. 5 is a flow chart 500 of illustrative steps involved in determining information from transformed signal by tuning a wavelet transform at one or more scale bands of interest in accordance with an embodiment. The steps of flow chart 500 may be performed by processor 412, or may be performed by any suitable processing device communicatively coupled to monitor 14. The steps of flow chart 500 may be performed by a digital processing device, or implemented in analog hardware. It will be noted that the steps of flow chart 500 may be performed in any suitable order, and certain steps may be omitted entirely.

The steps of flow chart 500 may be executed over a sliding window of a signal. For example, the steps of flow chart 500 may involve analyzing the previous N samples of a signal, or the signal received over the previous T units of time. The length of the sliding window over which the steps of flow chart 500 is executed may be fixed or dynamic. In an embodiment, the length of the sliding window may be based at least in part on the noise content of a signal. For example, the length of the sliding window may increase with increasing noise, as may be determined by a noise assessment. In an embodiment, the steps of flow chart 500 may be executed on one or more signals retrieved from memory. For example, the steps of flow chart 500 may involve analyzing one or more signals that were previously stored in ROM 52, RAM 52, and/or QSM 72 (FIG. 2(b)) in the past and may be accessed by microprocessor 48 within monitor 14 to be processed.

At step 502, at least one signal is received. The signal (e.g., a PPG signal) may be received from any suitable source (e.g., patient 40) using any suitable technique. A received signal may be generated by sensor unit 12, which may itself include any of the number of physiological sensors described herein. A received signal may be signal 416, which may be generated by a pre-processor 420 coupled between processor 412 and sensing device 418. A received signal may include multiple signals (e.g., first and second signals), or multiple signal components. Additionally, a signal received at step 502 may be a derived signal generated internally to processor 412. Accordingly, a received signal may be based at least in part on a filtered version of a signal 416, or a combination of multiple signals. For example, a received signal may be a ratio of two signals. A received signal may be a transformation of a signal 416, such as a continuous wavelet transformation of a signal 416. A received signal may be based at least in part on past values of a signal, such as signal 416, which may be retrieved by processor 412 from a memory such as a buffer memory or RAM 54, A received signal may include one or more signals within the received signal.

In an embodiment, a signal received at step 502 may be a PPG signal which may be obtained from sensor 12 that may be coupled to patient 40. A PPG signal may be obtained from input signal generator 410, which may include pre-processor 420 coupled to sensor 418, which may provide as input signal 416 a PPG signal. In an embodiment, a PPG signal may be obtained from patient 40 using sensor 12 or input signal generator 410 in real time. In an embodiment, a PPG signal may have been stored in ROM 52, RAM 52, and/or QSM 72 (FIG. 2) in the past and may be accessed by microprocessor 48 within monitor 14 to be processed. One or more PPG signals may be received as input signal 416 and may include one or more of a Red PPG signal and an IR PPG signal. In an embodiment, a first signal may be a Red PPG signal, and a second signal may be an IR PPG signal. In an embodiment, a first and second signal may be different types of signals (e.g., a blood pressure signal and a pulse rate signal). In an embodiment, a first and second signal may be obtained by first and second sensors located at approximately the same body site. In an embodiment, first and second signals may be obtained by first and second sensors located at different body sites.

In an embodiment, more than two signals may be received at step 502. For example, PPG signals at three or more frequencies may be obtained at step 502. It will be noted that the steps of flow chart 500 may be applied to any number of received signals by application of the techniques described herein.

In an embodiment, pre- or post-processing techniques may be applied to one or more of the signals received at step 502. These techniques may include any one or more of the following: compressing, multiplexing, modulating, up-sampling, down-sampling, smoothing, taking a median or other statistic of the received signal, removing erroneous regions of the received signal, or any combination thereof.

In an embodiment, the at least one signal received at step 502 may be filtered using any suitable filtering technique. For example, a signal received at sensor 12 may be filtered by a low pass filter 68 prior to undergoing additional processing at microprocessor 48 within patient monitoring system 10. The low pass filter 68 may selectively remove frequencies that may later be ignored by a transformation or other processing step, which may advantageously reduce computational time and memory requirements. In an embodiment, a signal received at step 502 may be high or band pass filtered to remove low frequencies. Such a filter may be, for example, a derivative filter. In an embodiment, a signal received at step 502 may be filtered to remove a DC component. In an embodiment, a signal received at step 502 may be normalized by dividing the signal by a DC component. In an embodiment, the cutoff frequencies of a filter may be chosen based on the frequency response of the hardware platform underlying patient monitoring system 10.

Different operations, which may include transformation, processing and/or filtering techniques, may be applied to any one or more of the signals received at step 502 and/or any components of a multi-component signal. For example, different operations may be applied to a Red PPG signal and an IR PPG signal. An operation may be applied to a portion or portions of a received signal. An operation may be broken into one or more stages performed by one or more devices within signal processing system 400 (which may itself be a part of patient monitoring system 10). For example, a filtering technique may be applied by input signal generator 410 prior to passing the resulting input signal 416 to processor 412. Embodiments of the steps of flow chart 500 include any of the operations described herein performed in any suitable order.

At step 504, a first characteristic frequency, ωₒ₁, is determined. In certain embodiments the first characteristic frequency, ωₒ₁, corresponds to a first scale band of interest. A scale band of interest may include a particular scale or range of scales of a scalogram that may include any suitable desired information, (e.g., pulse information, breathing information, or both). In certain embodiments, a characteristic frequency, ωₒ, may be determined based at least in part on the amplitude of a peak in a scalogram at one or more particular scales of interest. In certain embodiments, one or more desired characteristic frequencies may be known. In certain embodiments, the characteristic frequency, ωₒ, may be determined based on other criteria or characteristics of the signal, (e.g., a scale being considered, the nature of the signal component being analyzed, morphology of the signal, the noise level at the scale and/or time of occurrence of the signal component being analyzed, the signal-to-noise ratio at the scale and/or time of occurrence of the signal component being analyzed, or any combinations thereof). In certain embodiments, the characteristic frequency, ωₒ, is chosen to achieve a desired output in a scalogram. For example, a characteristic frequency, ωₒ, may be chosen to resolve a peak out of noise. By resolving one or more scalogram peaks out of the noise, components of the received signal may be more effectively recognized, analyzed or both. For example, by resolving the scalogram peaks out of the noise, pulse components of a physiological signal may be analyzed for use in the determination of an SPO2 value.

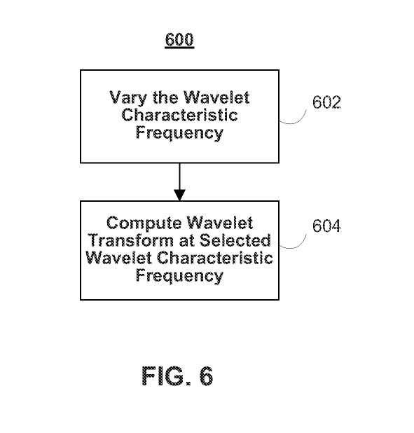

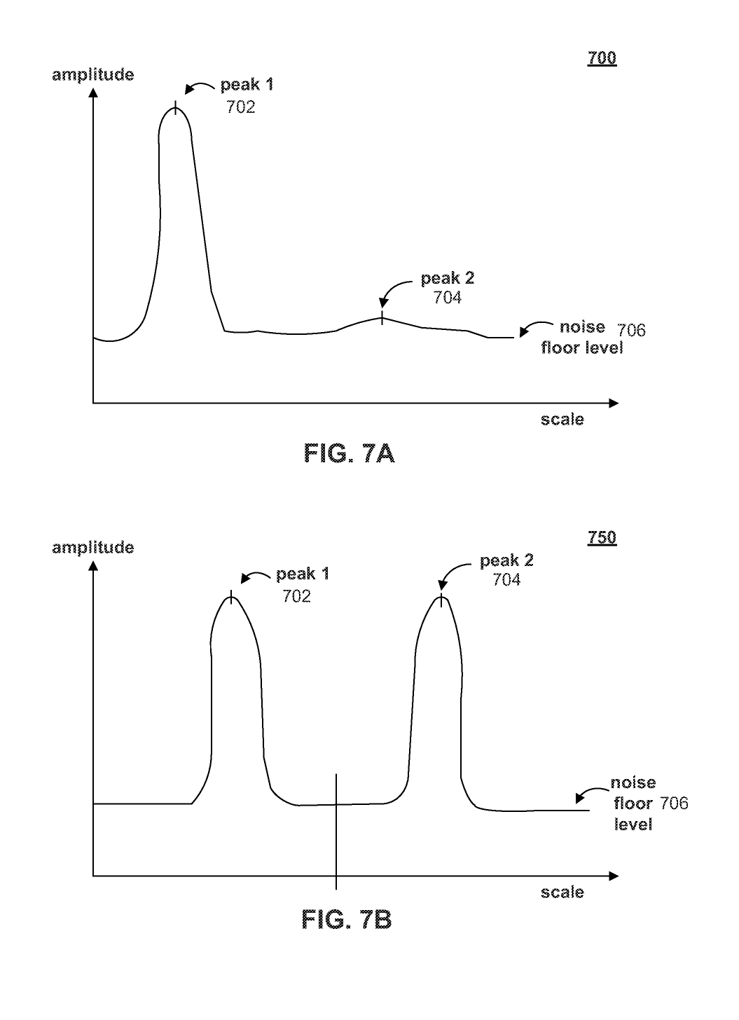

Once a first characteristic frequency, ωₒ₁, is determined at step 504, a first wavelet function may be tuned to the first characteristic frequency, ωₒ₁, at step 506. In certain embodiments, the first wavelet function may be tuned to the first characteristic frequency, ωₒ₁, in at least a region of a first scale band of interest. More detail about tuning the wavelet transform is given below with respect to FIG. 6. The characteristic frequency of the first wavelet function may be tuned to the first characteristic frequency, ωₒ₁, to, for example, produce better definition in a wavelet transform for repeating signal features. In an embodiment, increasing the wavelet characteristic frequency may produce a more defined band or bands in the transform for repeating signal features. The wavelet function may be tuned to increase the signal-to-noise ratio. For example, FIGS. 7A and 7B illustrate the effect of tuning a wavelet function and transforming a signal based on the tuned wavelet function to pull the signal out of a noise floor by increasing the characteristic frequency of the wavelet function.

In FIG. 7A, plot 700 shows peak 702, peak 704, and noise floor level 706. The band centered at peak 702 is at a larger scale compared to the band centered at peak 704. In certain embodiments, a wavelet transform of a signal with two repeating signal components of the same amplitude will have a lower amplitude at smaller scales and be more spread out over scales due to the nature of the wavelet transform. For example, the signal component represented by peak 704 has the same amplitude as the signal component represented by peak 702, however since peak 704 is at a smaller scale, it has a lower amplitude than peak 702 and is more spread out. In cases where there is a significant constant level noise floor, such as noise floor 706, the band at the smaller scales may disappear first into the noise. In FIG. 7B, the characteristic frequency of the wavelet function used to compute peak 704 is increased, while the characteristic frequency of the wavelet function used to compute peak 702 remains the same. The result is that the peak 704 band is more defined band and has been pulled out of the noise floor 706.

Once the first wavelet function has been tuned to the first characteristic frequency, ωₒ₁, in at least a region of a first scale band of interest at step 506, a second characteristic frequency, ωₒ, may be determined at step 508. In certain embodiments, the first and second characteristic frequencies may be known before the first and second wavelet functions are tuned in steps 506 and 510. In certain embodiments the second characteristic frequency, ωₒ₂, corresponds to a second scale band of interest. The first band of interest and/or the second band of interest may, for example, represent pulse components, breathing components or a combination of both. In certain embodiments the characteristic frequency, ωₒ, may be determined based at least in part on the amplitude of a band in a scalogram at a particular scale of interest. In certain embodiments, one or more desired characteristic frequencies may be known. In certain embodiments, the characteristic frequency, ωₒ, may be determined based on other criteria or characteristics of the signal, (e.g., a scale being considered, the nature of the signal component being analyzed, the noise level at the scale and/or time of occurrence of the signal component being analyzed, the signal-to-noise ratio at the scale and/or time of occurrence of the signal component being analyzed, or any combinations thereof). In certain embodiments, the characteristic frequency, ωₒ, is chosen to achieve a desired output in a scalogram. For example, a characteristic frequency, ωₒ, may be chosen to resolve a peak out of noise as described above. In certain embodiments, updated first and second characteristic frequencies are determined dynamically in time. For example, the first and/or second characteristic frequencies may be determined based on a changing parameter or may be scanned across the surface of a scalogram. In certain embodiments, the first and second characteristic frequencies may be known, and may be changed to produce an updated wavelet transform and scalogram.

Once a second characteristic frequency, ωₒ₂, is determined at step 508, the second wavelet function is tuned to the second characteristic frequency, ωₒ₂, at step 510. In certain embodiments, the second wavelet function is tuned to the second characteristic frequency, ωₒ₂, in at least a region of a second scale band of interest. The characteristic frequency of the wavelet function may be tuned to the second characteristic frequency, ωₒ₂, to produce better definition in a wavelet transform for repeating signal features. In an example, the wavelet function may be tuned to increase the signal-to-noise ratio. At least one physiological parameter may be computed based at least in part on tuning the wavelet function to one or both of the first and second characteristic frequencies. For example, SₚO₂ may be computed as a result of tuning the wavelet function to produce better definition in a band of interest in wavelet transform calculated based on the wavelet function. In certain embodiments, the first and second characteristic frequencies may be the same. In an embodiment, the first and second characteristic frequencies are determined such that when the wavelet function is tuned and a wavelet transform is calculated based on both the first and second wavelet functions, the amplitude associated with the second band of interest is approximately equal to the amplitude associated with the first band of interest.

In an embodiment, one or more of the first and second wavelet functions calculated in steps 506 and 510 may be used to transform the signal in step 512. A transformation may occur using one of the first and second wavelet functions, a combination of both, or one or both of the first and second wavelet functions may be combined with one or more other wavelet functions. In an embodiment, processor 412 may transform the signal into any suitable domain, for example, a Fourier, wavelet, spectral, scale, time, time-spectral, time-scale domain, or any transform space. This transformation may be performed by any one or more of the transformation techniques described herein, including a continuous wavelet transformation. The continuous wavelet transform function may be based at least in part on a wavelet function, as described above. In an embodiment, the continuous wavelet transform utilizes a Morlet wavelet, a Mexican Hat wavelet, any suitable wavelet, or any combination thereof. This transformation may be performed by any suitable processing device, such as processor 412 and/or microprocessor 48, which may each be a general-purpose computing device or a specialized processor. The transformation may also be performed by a separate, dedicated device. Processor 412 may further transform the original and/or transformed signals into any suitable domain. In an embodiment, a transformation may be based at least in part on a continuous wavelet transformation. For example, a PPG signal may be transformed using a continuous wavelet transform as described above with reference to FIG. 3(c). In an embodiment, a transformation may include performing a continuous wavelet transform for one or more PPG signals received, for example, at step 502, including an IR PPG signal, a Red PPG signal, or any combination of signals.

In an embodiment, a scalogram may be generated in step 514 as part of a transformation of one or more of the signals received at step 502 using a combination of the wavelet functions calculated in steps 506 and 508. In certain embodiments, the scalogram is generated based on the transform signal found in step 512. A scalogram may be generated by any of the techniques described herein, including those described above with reference to FIGS. 3(a) and 3(b). For example, processor 412 or microprocessor 48 may perform the calculations associated with the continuous wavelet transform of a signal and the derivation of the scalogram. In an embodiment, a scalogram may be based on any one or more features of a transformed signal. For example, a scalogram may represent the real part of a transformed signal, the imaginary part of a transformed signal, the modulus of a transformed signal, any other suitable feature of the transformed signal, or any combination thereof. In an embodiment, one or more of the signals received at step 502 may represent a scalogram of a signal. For example, a first received signal may be a continuous wavelet transformation of a Red PPG signal, and a second received signal may be a continuous wavelet transformation of an IR PPG signal. In certain embodiments, step 514 may be removed from the process, and a scalogram may not be generated. It will be understood that the steps of flow chart 500 may be carried out in an order other than what is depicted in FIG. 5. For example, the wavelet functions may be tuned after the signal is transformed.

FIG. 6 is a flow chart 600 of illustrative steps involved in tuning and computing a wavelet transform in accordance with an embodiment. The steps of flow chart 600 may be performed by processor 412, or may be performed by any suitable processing device communicatively coupled to monitor 14. The steps of flow chart 600 may be performed by a digital processing device, or implemented in analog hardware. It will be noted that the steps of flow chart 600 may be performed in any suitable order, and certain steps may be omitted entirely.

As described with respect to FIGS. 7A and 7B, the wavelet characteristic frequency may be increased to provide a more defined band in wavelet space, to pull a band of interest out of noise that may be present for any other suitable purpose, or for any combination thereof. Universally increasing the wavelet characteristic frequency may require that the window lengths for each of the wavelets used at each scale be increased accordingly. This may prevent the transform from tracking rapid changes in signal properties. For example, signal changes at larger scales will not track as quickly with a larger window length. In certain clinical settings, a shorter transform length may be desired, (e.g., for efficient memory storage, or for tracking a rapid response in a physiological signal). Additionally, larger wavelet periods contained within limited sized scalograms may cause problems with edge effects.

To avoid these potential problems, the wavelet characteristic frequency may be varied in accordance with step 602 so that only one or more regions of the transform surface are tuned. For example, the wavelet characteristic frequency may be set to one or more particular characteristic frequencies as determined in steps 504 and 508 of flow chart 500. In certain embodiments, the wavelet characteristic frequency is varied according to one or more positions of interest across a transform surface. For example, the wavelet characteristic frequency may be varied with respect to distinct regions corresponding to the vicinity of one or more peaks. In certain embodiments, the wavelet characteristic frequency is varied so that some or all peaks in a scalogram have substantially the same amplitude. For a constant amplitude noise floor in the transform domain this may ensure that each peak is resolved to the same degree (i.e. each peak is resolved to the same signal-to-noise ratio). For example, as shown in FIG. 7B, peak 702 is computed at a first wavelet characteristic frequency and peak 704 is computed a second wavelet characteristic frequency chosen to display peak 704 at substantially the same amplitude as peak 702.

At step 604, the wavelet transform is computed at the wavelet characteristic frequency selected in step 602. In certain embodiments, the wavelet transform is computed based on one or more wavelet functions. In an embodiment, processor 412 may transform the signal, using the determined characteristic frequency and window length, into any suitable domain, for example, a Fourier, wavelet, spectral, scale, time, time-spectral, time-scale domain, or any transform space. This transformation may be performed by any one or more of the transformation techniques described herein, including a continuous wavelet transformation. The continuous wavelet transform function may be based at least in part on a wavelet function, as described above. This transformation may be performed by any suitable processing device, such as processor 412 and/or microprocessor 48, which may each be a general-purpose computing device or a specialized processor. The transformation may also be performed by a separate, dedicated device. Processor 412 may further transform the original and/or transformed signals into any suitable domain. In an embodiment, a transformation may be based at least in part on a continuous wavelet transformation. For example, a PPG signal may be transformed using a continuous wavelet transform as described above with reference to FIG. 3(c).

In an embodiment, a scalogram may be generated in step 604 as part of computing the wavelet transform. A scalogram may be generated by any of the techniques described herein, including those described above with reference to FIGS. 3(a) and 3(b). For example, processor 412 or microprocessor 48 may perform the calculations associated with the continuous wavelet transform of a signal and the derivation of the scalogram.

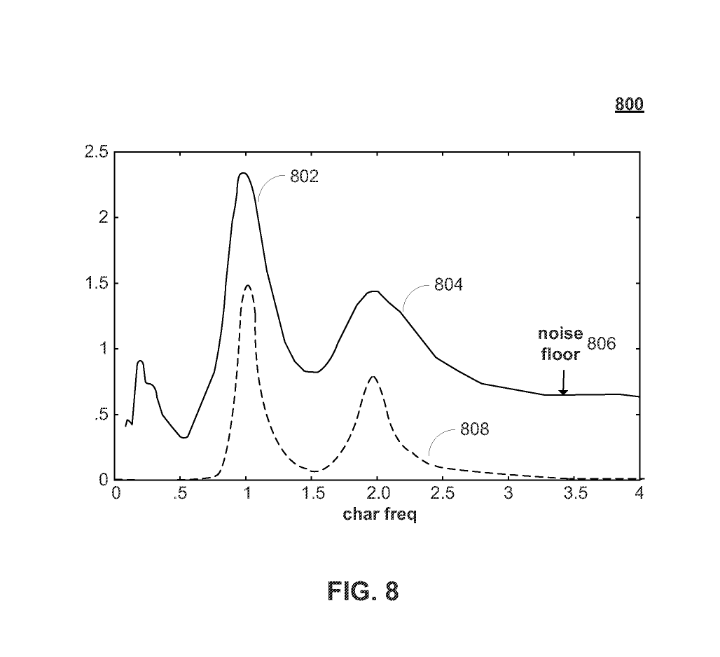

FIGS. 8-10 show an example of the method as described with respect to flow charts 500 and 600. FIG. 8 shows plot 800 having two bands 802 and 804 in wavelet space from a signal comprising two sinusoidal signals with equal amplitudes. The wavelet transform of FIG. 8 is computed at a wavelet characteristic frequency of 5.5. The higher characteristic frequency of band 804 results in a lower amplitude peak. Additionally, Gaussian white noise is added to each sinusoidal signal resulting in noise floor 806. The added Gaussian white noise may be representative of patient movement or certain types of hardware noise in a clinical setting. Dashed line 808 represents the theoretical distribution expected from the signals without noise. As shown in FIG. 8, the noise may have an additive effect on the signal.

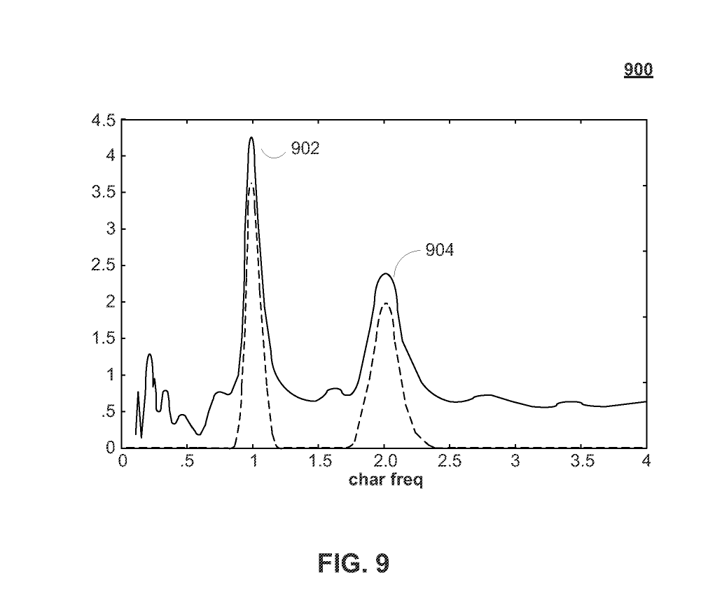

FIG. 9 shows plot 900 having bands 902 and 904 in wavelet space from the same two sinusoidal signals. The wavelet transform of FIG. 9 is computed at a wavelet characteristic frequency of 12.5. By computing the wavelet transform at a larger wavelet characteristic frequency, the amplitudes of both bands 902 and 904 increase. Additionally, the signal-to-noise ratio of both bands 902 and 904 increases as a result of the increased wavelet characteristic frequency.

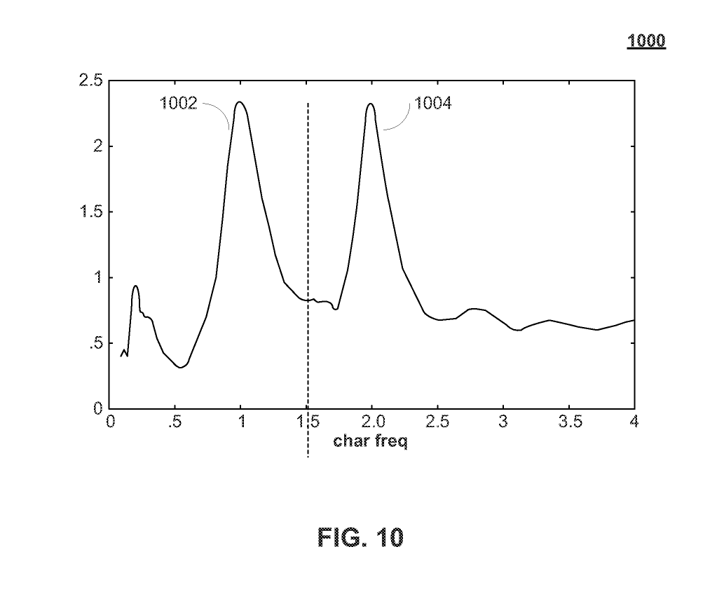

FIG. 10 shows an example of the result of using the methods described in flow charts 500 and 600. As shown in plot 1000, the wavelet transform has been tuned in accordance with flow chart 600 across the surface of the transform resulting in peaks 1002 and 1004 having substantially similar amplitudes. Peak 1002 is calculated at a wavelet characteristic frequency of 5.5, while peak 1004 is calculated at a wavelet characteristic frequency of 12.5. In certain embodiments, the relative values of the wavelet characteristic frequencies required to produce two or more bands of equal amplitude depend on the amplitude of the relative signal components making up the bands, the morphology of the signal components making up the bands, the noise level the specific realization of the noise over the region or any combination of these parameters.

It will be understood by those of skill in the art that tuning a wavelet transform may involve methods other than steps given in flow charts 500 and 600. For example, other steps may be performed. Additionally, the systems and methods described herein may be used with other transformation and other realization of signals at multiple scales where an intrinsic period or periods may be determined.

It will be understood that the systems and methods described herein include any combination of the above-described embodiments. Additionally, the systems and methods described herein (e.g., systems for implementing the steps illustrated in one or more of flow charts 500 and 600) may be applied to time domain signals, wavelet domain signals, signals in any suitable domain, or any combination thereof. It will also be understood that the above method may be implemented using any human-readable or machine-readable instructions on any suitable system or apparatus, such as those described herein.

The foregoing is merely illustrative of the principles of this disclosure and various modifications can be made by those skilled in the art without departing from the scope and spirit of the disclosure. The following claims may also describe various aspects of this disclosure.

1. A method for processing a signal, comprising:
receiving the signal;
using specialized processing hardware and software for:
determining a first characteristic frequency corresponding to a first scale band of interest;
tuning a first wavelet function to the first characteristic frequency in at least a region of the first scale band of interest;
determining a second characteristic frequency corresponding to a second scale band of interest;
tuning a second wavelet function to the second characteristic frequency in at least a region of the second scale band of interest;
transforming the signal using a wavelet transform for the first and second wavelet functions to generate a transform signal; and
generating a scalogram for at least the first and second scale bands of interest based at least in part on the transform signal.

2. The method of claim 1, wherein the first and second characteristic frequencies are determined such that an amplitude associated with the second scale band of interest is approximately equal to an amplitude associated with the first scale band of interest.

3. The method of claim 1, further comprising determining updated first and second characteristic frequencies dynamically in time.

4. The method of claim 1, wherein the first and second characteristic frequencies are determined based at least in part on at least one characteristic of the signal.

5. The method of claim 4, wherein the at least one characteristic of the signal comprises noise level, signal-to-noise ratio, morphology of signal components, scale, and/or time of occurrence, or a combination thereof.

6. The method of claim 1, wherein at least one of the first and second wavelet functions are tuned to a particular characteristic frequency to produce better definition in the wavelet transform for repeating signal features.

7. The method of claim 1, wherein the signal is a photoplethysmograph signal.

8. The method of claim 6, wherein the first scale band of interest and the second scale band of interest represent pulse components and breathing components.

9. The method of claim 6, further comprising computing at least one physiological parameter based at least in part on the tuning to the first and second characteristic frequencies.

10. The method of claim 1, wherein at least one of the first and second wavelet functions is tuned to increase to the signal-to-noise ratio.

11. A system for processing a signal, comprising:
a receiver that receives the signal;
specialized processing hardware and software for:
determining a first characteristic frequency corresponding to a first scale band of interest;
tuning a first wavelet function to the first characteristic frequency in at least a region of the first scale band of interest;
determining a second characteristic frequency corresponding to a second scale band of interest; and
tuning a second wavelet function to the second characteristic frequency in at least a region of the second scale band of interest;
transforming the signal using a wavelet transform for the first and second wavelet functions to generate a transform signal; and
generating a scalogram for at least the first and second scale bands of interest based at least in part on the transform signal.

12. The system of claim 11, wherein the first and second characteristic frequencies are determined such that an amplitude associated with the second scale band of interest is approximately equal to an amplitude associated with the first scale band of interest.

13. The system of claim 11, wherein the specialized hardware and software determines updated first and second characteristic frequencies dynamically in time.

14. The system of claim 11, wherein the first and second characteristic frequencies are determined based at least in part on at least one characteristic of the signal.

15. The system of claim 14, wherein the at least one characteristic of the signal comprises noise level, signal-to-noise ratio, morphology of signal components, scale, and/or time of occurrence, or a combination thereof.

16. The system of claim 11, wherein at least one of the first and second wavelet functions is tuned to a particular characteristic frequency to produce better definition in the wavelet transform for repeating signal features.

17. The system of claim 11, wherein the signal is a photoplethysmograph signal.

18. The system of claim 11, wherein the first band of interest and the second band of interest represent pulse components and breathing components.

19. The system of claim 11, wherein the specialized hardware and software computes at least one physiological parameter based at least in part on the tuning to the first and second characteristic frequencies.

20. The system of claim 11, wherein the wavelet transform is tuned to increase to the signal-to-noise ratio.
